(19) United States
(12) Patent Application Publication
(10) Pub. No.: US 2007/0086141 A1
(43) Pub. Date: Apr. 19, 2007

(54) Surge receptacle apparatus and power system including the same

(75) Inventor: Robert T. Elms, Monroeville, PA (US)

Correspondence Address: MARTIN J. MORAN, ESQ.;Eaton Electrical, Inc., Technology & Quality Center, 170 Industry Drive, RIDC Park West, Pittsburgh, PA, 15275-1032, US

(73) Assignee: EATON CORPORATION

(21) Appl. No.: 11/252,907

(22) Filed: Oct. 18, 2005

(51) Int. Cl. H02H 9/06

(52) U.S. Cl. 361/118

(57) ABSTRACT

A power system includes a circuit interrupter providing ground fault protection for a power circuit, and a surge receptacle powered through the circuit interrupter. The surge receptacle includes a line, neutral and ground terminals electrically interconnected with respective line, neutral and ground conductors of the power circuit, plural receptacles electrically interconnected with the line, neutral and ground terminals, and a surge suppression circuit. The surge suppression circuit includes a first MOV electrically connected between the line and neutral terminals and having a first voltage rating, a second MOV electrically connected between the neutral and ground terminals and having a second voltage rating which is about equal to the first voltage rating, and a third MOV electrically connected between the line and ground terminals. The third MOV has a third voltage rating which is about 30 V_{RMS} to about 50 V_{RMS} greater than the first and second voltage ratings.

### BACKGROUND OF THE INVENTION

1. Field of the Invention

This invention pertains generally to power systems and, more particularly, to power systems employing surge suppression. The invention also relates to surge suppression apparatus and, more particularly, to surge receptacle apparatus.

2. Background Information

With the wide use of computers and other relatively expensive electronic equipment, users, such as, for example, homeowners, are protecting their investments with “surge strips” (e.g., without limitation, apparatus including an extension cord and one or more electrical receptacles or outlets providing surge suppression, such as, for example, MOV-based over-voltage protection) or “surface receptacles”. Unfortunately, the present design of these surge strips or surface receptacles may cause significant ground current to flow whenever significant surge suppression, such as, for example, significant over-voltage clamping, occurs. This ground current, in turn, may cause what appears to be nuisance tripping of upstream GFCI or AFCI/GFCI circuit breakers.

FIG. 1 shows a conventional surge strip 2, which has three 130 V_{RMS} MOVs 4,6,8. The MOVs 4,6,8 are electrically connected line-to-neutral, neutral-to-ground and line-to-ground. Nuisance tripping occurs when a line-to-neutral or line-to-ground voltage transient occurs with sufficient voltage amplitude to cause the MOV 8 to clamp the voltage. Under the “National Electric Code” (NEC), the neutral conductor 10 is electrically connected to the ground conductor 12 at an upstream load center or panel board (not shown). The MOVs conduct available current when they reach their clamping voltage. As such, MOV 4 and MOV 8, which have the same voltage rating, conduct the surge current from the line conductor 14 of the surge strip 2. The line current in MOV 4 flows to the neutral conductor 10 and is harmlessly dissipated. The line current in MOV 8 flows to the surge strip ground conductor 12. This current of MOV 8, thus, appears as a ground fault current to any upstream circuit breaker (not shown) protecting that branch circuit. This voltage surge is transient in nature and the surge strip 2 harmlessly dissipates the energy. If the upstream circuit breaker provides ground fault protection, then that circuit breaker will trip, which will be considered to be a nuisance trip. For example, it is believed that 300 V transients are sufficient to cause nuisance tripping of upstream AFCI/GFCI or GFCI circuit breakers.

There is a safety concern with the expanded use of ground fault protection. For example, known transient voltage surge suppressor (TVSS) cord-connected devices use voltage clamping devices with equal clamping voltage ratings from line-to-neutral and from line-to-ground. With such a design, under line-to-neutral surge conditions in, for example, a residential installation, surge fault current will be conducted equally from line-to-neutral and line-to-ground. This ground fault current in the ground conductor will cause a perceived nuisance tripping of ground fault protective devices when no true ground fault condition exists. The user, such as a homeowner, may well be tempted to remove the ground fault protection in order to eliminate the perceived nuisance tripping. This is a substantial safety concern. In a residential installation, where the neutral is bonded to the grounding impedance, line-to-ground TVSS protection may introduce voltages on the ground conductors instead of limiting them during line transient events. This has the potential to create unsafe ground voltages instead of reducing them.

The switching of capacitors for line voltage regulation purposes has been identified as a source of frequent transients (e.g., several times a week) creating twice the peak line voltage (see, for example, IEEE C62.41-1991).

The grounding conductor is a non-current carrying conductor per NEC § 250 “Grounding and Bonding” (2005). NEC § 250.4 (A) states that a purpose of grounding is to “limit the voltage imposed by lightning line surges”. This section also specifies that grounding of electrical equipment is intended to be non-current carrying. NEC § 250.6 “Temporary Currents Not Classified as Objectionable Currents” describes acceptable currents in the grounding conductors as including temporary currents in the grounding conductors resulting from accidental ground faults or resulting from the grounding conductors doing their protective function as being not objectionable.

Accordingly, there is room for improvement in power systems and surge receptacle apparatus.

### SUMMARY OF THE INVENTION

These needs and others are met by the present invention, which provides a surge receptacle apparatus that substantially reduces nuisance trips of upstream interrupters with ground fault protection.

In accordance with one aspect of the invention, a power system for a power circuit including a line conductor, a neutral conductor and a ground conductor comprises: a circuit interrupter structured to provide ground fault protection for the power circuit; and a surge receptacle apparatus powered through the circuit interrupter, the surge receptacle apparatus comprising: a line terminal electrically interconnected with the line conductor, a neutral terminal electrically interconnected with the neutral conductor, a ground terminal electrically interconnected with the ground conductor, a number of outputs electrically interconnected with the line terminal, the neutral terminal and the ground terminal, and a surge suppression circuit comprising: (a) a first surge suppression device electrically connected between the line terminal and the neutral terminal and including a first voltage rating, a second surge suppression device electrically connected between the neutral terminal and the ground terminal and including a second smaller voltage rating of about 30 V_{RMS} to about 50 V_{RMS}, and generally no over-voltage protection device between the line terminal and the ground terminal other than the series combination of the first and second surge suppression devices, or (b) a third surge suppression device electrically connected between the line terminal and the neutral terminal and including a third voltage rating, a fourth surge suppression device electrically connected between the neutral terminal and the ground terminal and including a fourth voltage rating which is about equal to the third voltage rating, and a fifth surge suppression device electrically connected between the line terminal and the ground terminal, the fifth surge suppression device including a fifth voltage rating which is about 30 V_{RMS} to about 50 V_{RMS} greater than the third and fourth voltage ratings, wherein a limited energy line-to-neutral fault between the line terminal and the neutral terminal or a limited energy line-to-ground fault between the line terminal and the ground terminal above a first predetermined magnitude will produce a ground fault current in the ground conductor sufficient to trip the circuit interrupter, and wherein a limited energy line-to-neutral fault between the line terminal and the neutral terminal or a limited energy line-to-ground fault between the line terminal and the ground terminal below the first predetermined magnitude and above a second predetermined magnitude, which is less than the first predetermined magnitude, will produce a ground current in the ground conductor insufficient to trip the circuit interrupter.

The surge suppression circuit may comprise the third, fourth and fifth suppression devices, and the third and fourth voltage ratings may be about 130 V_{RMS}.

The surge suppression circuit may comprise the first and second surge suppression devices and may generally have no over-voltage protection device between the line terminal and the ground terminal other than the series combination of the first and second surge suppression devices. The first voltage rating of the first surge suppression device may be about 130 V_{RMS}.

As another aspect of the invention, a surge receptacle apparatus comprises: a line terminal; a neutral terminal; a ground terminal; a number of outputs electrically interconnected with the line terminal, the neutral terminal and the ground terminal; a first surge suppression device electrically connected between the line terminal and the neutral terminal, the first surge suppression device including a first voltage rating; a second surge suppression device electrically connected between the neutral terminal and the ground terminal, the second surge suppression device including a second voltage rating which is about equal to the first voltage rating; and a third surge suppression device electrically connected between the line terminal and the ground terminal, the third surge suppression device including a third voltage rating which is about 30 V_{RMS} to about 50 V_{RMS} greater than the first and second voltage ratings.

The first and second voltage ratings may be about 130 V_{RMS}.

As another aspect of the invention, a surge receptacle apparatus comprises: a line terminal; a neutral terminal; a ground terminal; a number of outputs electrically interconnected with the line terminal, the neutral terminal and the ground terminal; a first surge suppression device electrically connected between the line terminal and the neutral terminal, the first surge suppression device including a first voltage rating; and a second surge suppression device electrically connected between the neutral terminal and the ground terminal, the second surge suppression device including a second smaller voltage rating of about 30 V_{RMS} to about 50 V_{RMS}, wherein the surge receptacle apparatus generally has no over-voltage protection device between the line terminal and the ground terminal other than the series combination of the first and second surge suppression devices.

The first voltage rating of the first surge suppression device may be about 130 V_{RMS}.

The first voltage rating of the first surge suppression device may be about 80 V_{RMS} to about 100 V_{RMS} greater than the second voltage rating of the second surge suppression device.

The first surge suppression device may further include a first indicator circuit structured to indicate when the first fuse is open; and the second surge suppression device may further include a second indicator circuit structured to indicate when the second fuse is open.

The first surge suppression device may include a first fuse in series with a first metal oxide varistor, and the second surge suppression device may include a second fuse in series with a second metal oxide varistor. The first fuse may be electrically connected to the first metal oxide varistor at a node; the first surge suppression device may further include a resistor having first and second leads, a diode having an anode and a cathode, and a light having a first lead and a second lead; the first lead of the resistor may be electrically connected to the node; the second lead of the resistor may be electrically connected to the anode of the diode; the cathode of the diode may be electrically connected to the first lead of the light; and the second lead of the light may be electrically connected to the neutral terminal.

The second fuse may be electrically connected to the second metal oxide varistor at a node; the second surge suppression device may further include a resistor having first and second leads, first, second and third diodes each having an anode and a cathode, and a light having a first lead and a second lead; the first lead of the resistor may be electrically connected to the line terminal; the second lead of the resistor may be electrically connected to the anode of the first diode; the cathode of the first diode may be electrically connected to the anodes of the second and third diodes; the cathode of the second diode may be electrically connected to the first lead of the light; the second lead of the light may be electrically connected to the neutral terminal; and the cathode of the third diode may be electrically connected to the node.

### BRIEF DESCRIPTION OF THE DRAWINGS

A full understanding of the invention can be gained from the following description of the preferred embodiments when read in conjunction with the accompanying drawings in which:

FIG. 1 is a block diagram in schematic form of a surge strip.

FIGS. 2-4 are block diagrams in schematic form of surge receptacle apparatus in accordance with embodiments of the invention.

FIG. 5 is a block diagram in schematic form of a power system for a power circuit including one of the surge receptacle apparatus of FIGS. 2-4 in accordance with another embodiment of the invention.

### DESCRIPTION OF THE PREFERRED EMBODIMENTS

As employed herein, the term “number” shall mean one or an integer greater than one (i.e., a plurality).

As employed herein, the term “surge suppression” and variations thereof shall mean surge suppression, surge protection, over-voltage suppression and/or over-voltage protection. For example, a “transient voltage surge suppressor” (TVSS) is a device that attenuates (i.e., reduces in magnitude) random, high energy, short duration electrical power anomalies caused by, for example, electric utilities, atmospheric phenomena or inductive loads. Such anomalies may occur in the form of voltage and/or current spikes with a duration of less than about one-half of an alternating current (AC) line cycle. Such high energy power spikes may, otherwise, damage sensitive electronic equipment, such as computers, instrumentation or process controllers.

As employed herein, the term “surge suppression device” shall expressly include, and not be limited by, TVSSs, MOVs and other devices providing surge suppression.

As employed herein, the term “surge receptacle apparatus” shall expressly include, and not be limited by, “surge protector strips,” “surge strips,” “power surge strips,” “surge receptacles,” “wall-mounted surge receptacles,” “wall-mounted surge protectors,” “surface receptacles” and other devices structured to receive an AC source of power, provide surge suppression for such AC source of power, and output such surge suppressed AC source of power to a number of AC output(s).

As employed herein, examples values of V_{RMS} are nominal values and example ranges of V_{RMS} values are nominal ranges, all of which are understood to further have nominal manufacturing tolerances (e.g., without limitation, about ±10%). As a non-limiting example, as disclosed and claimed herein, a range of about 30 V_{RMS} to about 50 V_{RMS}, covers, for example, nominal manufacturing tolerances of about ±10% and, thus, covers the range of about 27 V_{RMS} to about 55 V_{RMS}.

### EXAMPLE 1

An example surge protector strip includes a power input (e.g., without limitation, a power cord), a housing, one or more surge suppression devices (e.g., without limitation, an EMI/RFI filter), and a plurality of AC power outputs (e.g., without limitation, outlets; receptacles). Such a surge protector strip may also include none, some or all of a power switch, a resettable circuit breaker that automatically turns-off in the event of a power overload, and a power indicator.

### EXAMPLE 2

A wall-mounted surge receptacle includes a power input (e.g., without limitation, terminals structured to engage a three-conductor AC power circuit), a body structured to engage a wall-mounted receptacle box and receptacle cover, one or more surge suppression devices, and one or two AC power outputs (e.g., without limitation, female three-terminal AC outlets or receptacles).

### EXAMPLE 3

A wall-mounted surge protector includes a power input (e.g., without limitation, a male three-prong plug structured to engage a female three-terminal AC outlet or receptacle), a housing, one or more surge suppression devices, and a plurality of AC power outputs (e.g., without limitation, female three-terminal AC outlets or receptacles). Such a wall-mounted surge protector may or may not include a power indicator light.

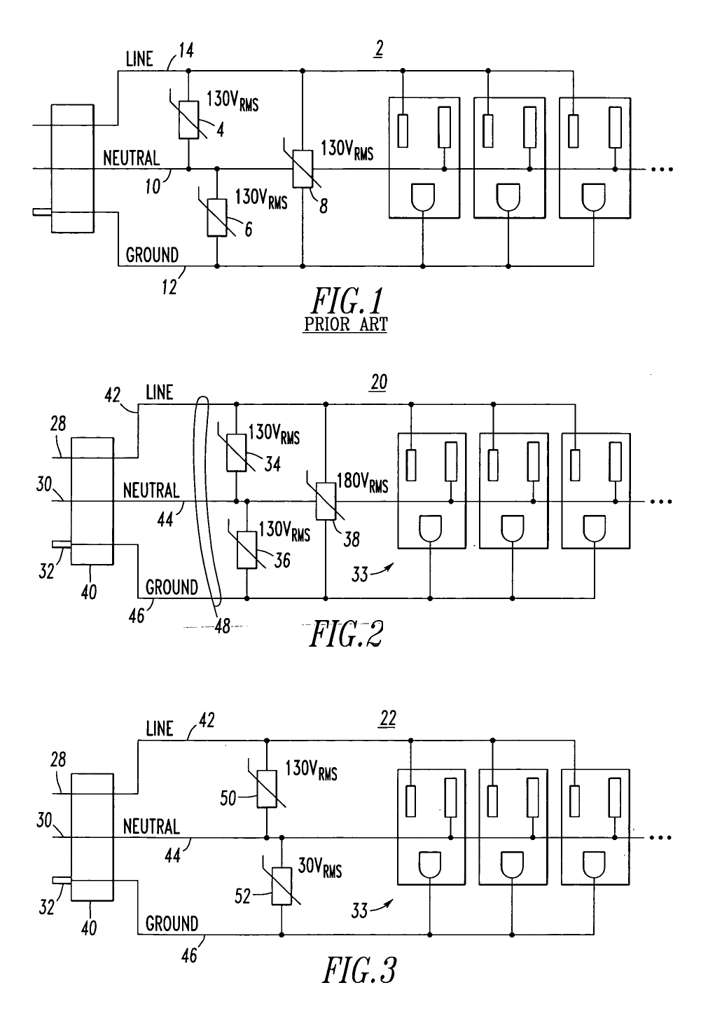

FIGS. 2-4 show example surge receptacle apparatus, such as surge strips 20, 22 and 24, which, when used with an upstream GFCI or AFCI/GFCI circuit breaker, such as GFCI 26 of FIG. 5, provide the user with surge protection, but without nuisance tripping. Here, the line voltage clamping is coordinated. In FIG. 2, when the line-to-neutral surge suppression device is doing its job, the line-to-ground surge suppression device does not create ground fault currents in the corresponding ground conductor since a ground fault does not exist and since the line voltage is being successfully clamped.

### EXAMPLE 4

Referring to FIG. 2, a surge receptacle apparatus, such as the surge strip 20, includes a line terminal 28, a neutral terminal 30, a ground terminal 32 and a plurality of outputs, such as female three-terminal AC outlets or receptacles 33, electrically interconnected with those terminals 28,30,32. A first surge suppression device, such as MOV 34 including an example about 130 V_{RMS} voltage rating, is electrically connected between the line and neutral terminals 28,30. A second surge suppression device, such as MOV 36 including an example about 130 V_{RMS} voltage rating, is electrically connected between the neutral and ground terminals 30,32. A third surge suppression device, such as MOV 38 including an example about 180 V_{RMS} voltage rating, is electrically connected between the line and ground terminals 28,32. This voltage rating of MOV 38 is preferably about 30 V_{RMS} to about 50 V_{RMS} greater than the voltage ratings of the MOVs 34,36. The selection of a line-to-ground clamping voltage rating of about 30 V_{RMS} to about 50 V_{RMS} (about 50 V to about 90 V) higher than the line-to-neutral clamping voltage rating eliminates nuisance tripping. The surge strip 20, thus, provides effective surge suppression, but does not nuisance trip on line-to-neutral voltage transients which have limited energy and which are not a direct lightning strike.

### EXAMPLE 5

Although MOVs 34,36,38 are shown in FIG. 2, any suitable surge suppression devices may be employed, each of which may or may not include a fuse in series with the corresponding surge suppression device.

### EXAMPLE 6

The line terminal 28, the neutral terminal 30 and the ground terminal 32 are disposed on a three-terminal plug 40. The terminals 28,30,32 are respectively electrically connected to a line conductor 42, a neutral conductor 44 and a ground conductor 46 of a power cord 48.

### EXAMPLE 7

The surge strip 22 of FIG. 3 is essentially the same as the surge strip 20 of FIG. 2, except that the three MOVs 34,36,38 are replaced by the two MOVs 50,52 as will be discussed. The surge strip 22 provides voltage surge suppression, but does not nuisance trip on line-to-neutral or line-to-ground voltage transients and, when combined with an upstream ground fault circuit breaker (e.g., about 5 mA for people protection to about 50 mA for equipment protection), such as GFCI 26 of FIG. 5, provides “loss-of-neutral” protection for that branch circuit. Here, loss-of-neutral protection is provided, since, in a non-faulted system, the neutral conductor 44 is electrically connected (as shown at 54 of FIG. 5) to the ground conductor 46 at a load center or panel board (not shown). As such, the neutral-to-ground voltage will normally be less than about a few volts. If the neutral connection 54 is lost, then the upstream ground fault circuit breaker, such as 26 of FIG. 5, protecting this branch circuit will trip when the neutral-to-ground voltage significantly exceeds the voltage of MOV 52 of FIG. 3.

### EXAMPLE 8

In this example, the first MOV 50 includes a first voltage rating, the second MOV 52 includes a second smaller voltage rating of about 30 V_{RMS} to about 50 V_{RMS}, and the surge strip 22 generally has no over-voltage protection device between the line terminal 42 and the ground terminal 46 other than the series combination of the MOVs 50,52. For example, the MOV 38 of FIG. 2 is not employed by the surge strip 22 of FIG. 3.

### EXAMPLE 9

The first voltage rating of the first MOV 50 is about 130 V_{RMS}.

### EXAMPLE 10

The first voltage rating of the first MOV 50 is about 80 V_{RMS} to about 100 V_{RMS} greater than the second voltage rating of the second MOV 52.

### EXAMPLE 11

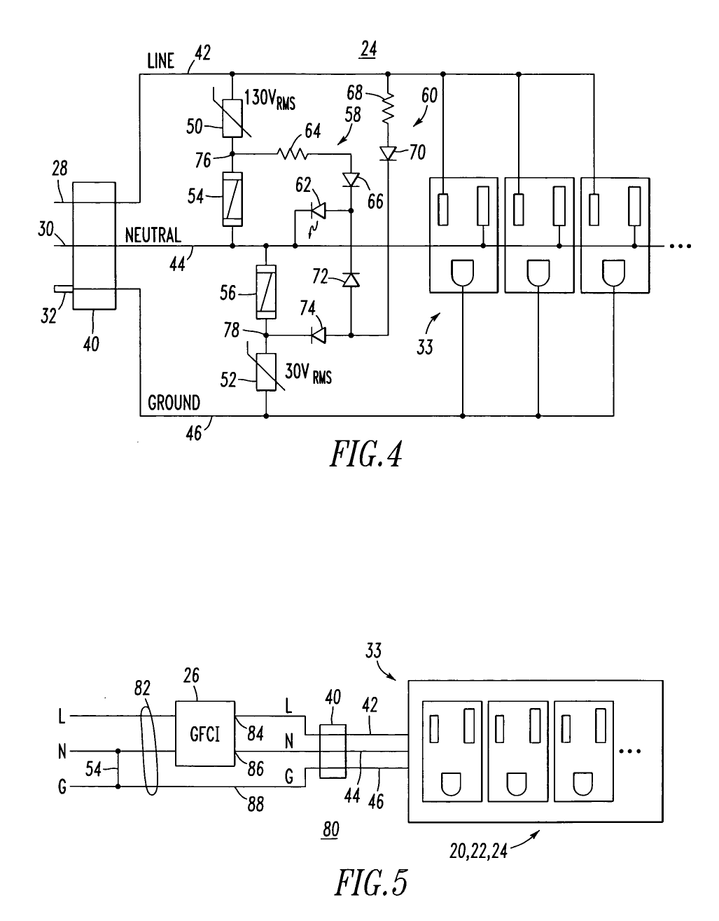

The surge strip 24 of FIG. 4 is essentially the same as the surge strip 22 of FIG. 3, except that two fuses 54,56 and two MOV failure indicator circuits 58,60 are employed. The first indicator circuit 58 indicates when the first fuse 54 is open and the first MOV 50 has failed. The second indicator circuit 60 indicates when the second fuse 56 is open and the second MOV 52 has failed. A single light, such as LED 62 (e.g., without limitation, red), is used to indicate MOV failure. When one or both of the MOVs 50,52 fail, they present a low impedance to the sustained voltage. To prevent fire, smoke or explosion, the fuses 54,56 are installed in series with the respective MOVs 50,52. If one of the MOVs 50,52 fails to a low impedance, then the corresponding fuse opens the circuit. If one or both of the fuses 54,56 opens, then the LED 62 is illuminated indicating failure and the need to replace the surge strip 24. If the first fuse 54 opens, then the LED 62 is powered through the series combination of the MOV 50, resistor 64 and diode 66 of the first MOV failure indicator circuit 58. If the second fuse 56 opens, then the LED 62 is powered through the series combination of resistor 68, diode 70 and diode 72 of the second MOV failure indicator circuit 60, which also includes a diode 74.

In the first MOV failure indicator circuit 58, the first fuse 54 is electrically connected to the first MOV 50 at node 76. One lead of the resistor 64 is electrically connected to the node 76 and the other lead of the resistor 64 is electrically connected to the anode of the diode 66. The cathode of the diode 66 is electrically connected to the anode the LED 62 and the cathode of the LED is electrically connected to the neutral conductor 44 and, thus, the neutral terminal 30.

For the second MOV failure indicator circuit 60, the second fuse 56 is electrically connected to the second MOV 56 at node 78. One lead of the resistor 68 is electrically connected to the line conductor 42 and, thus, the line terminal 28. The other lead of the resistor 68 is electrically connected to the anode of the first diode 70, while the cathode of the first diode 70 is electrically connected to the anodes of the second and third diodes 72,74. The cathode of the second diode 72 is electrically connected to the anode of the LED 62. The cathode of the third diode 74 is electrically connected to the node 78, in order to provide a path for current through the resistor 68 and the fuse 56 when the MOV 52 has not failed. Although the single LED 62 is employed, the circuits 58,62 may employ separate lights or LEDs (not shown).

### EXAMPLE 12

The example neutral-to-ground and line-to-neutral MOV voltage ratings of the surge strip 24 are selected in order that, for example, a one-cycle 240 V, limited energy (e.g., without limitation, supplied through a 2 Ω source impedance) line-to-neutral surge will not cause a perceived nuisance tripping of an upstream ground fault protective device, such as GFCI 26 of FIG. 5, feeding that circuit. The neutral conductor 44 is electrically connected to the ground conductor 46 upstream of the ground fault protective device. Under the example 240 V line-to-neutral one-cycle surge condition, the peak current in the ground conductor 46 is less than about 5 mA.

### EXAMPLE 13

FIG. 5 shows a power system 80 for a power circuit 82 including a surge receptacle apparatus, such as one of the surge strips 20,22,24 of FIGS. 2-4 in combination with the upstream GFCI 26. Although a GFCI is shown, the invention is applicable to a wide range of circuit interrupters providing ground fault protection for power circuits, such as 82. As shown in FIG. 5, the surge receptacle apparatus 20,22,24 is powered through the GFCI 26. The line terminal 28 is electrically interconnected with the line (load) conductor 84 from the GFCI 26, the neutral terminal 30 is electrically interconnected with the neutral (load neutral) conductor 86 from the GFCI 26, and the ground terminal 32 is electrically interconnected with the ground conductor 88.

### EXAMPLE 14

As a non-limiting example, for the surge strips 20,22,24 of FIGS. 2-5, a limited energy, line-to-neutral fault between the line terminal 28 and the neutral terminal 30 or a limited energy, line-to-ground fault between the line terminal 28 and the ground terminal 32 above a first predetermined magnitude, such as 4 kV, will produce a ground fault current in the ground conductor 88 sufficient (e.g., greater than about 5 mA for people protection) to trip the GFCI 26. On the other hand, a limited energy, line-to-neutral fault between the line terminal 28 and the neutral terminal 30 or a limited energy, line-to-ground fault between the line terminal 28 and the ground terminal 32 below the first predetermined magnitude, such as 4 kV, and above a smaller second predetermined magnitude, such as 2 kV, will produce a ground current in the ground conductor 88 insufficient (e.g., less than about 5 mA for people protection) to trip the GFCI 26.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A power system for a power circuit including a line conductor, a neutral conductor and a ground conductor, said power system comprising:
a circuit interrupter structured to provide ground fault protection for said power circuit; and
a surge receptacle apparatus powered through said circuit interrupter, said surge receptacle apparatus comprising:
a line terminal electrically interconnected with said line conductor,
a neutral terminal electrically interconnected with said neutral conductor,
a ground terminal electrically interconnected with said ground conductor,
a number of outputs electrically interconnected with said line terminal, said neutral terminal and said ground terminal, and
a surge suppression circuit comprising:
(a) a first surge suppression device electrically connected between said line terminal and said neutral terminal and including a first voltage rating, a second surge suppression device electrically connected between said neutral terminal and said ground terminal and including a second smaller voltage rating of about 30 V_{RMS} to about 50 V_{RMS}, and generally no over-voltage protection device between said line terminal and said ground terminal other than the series combination of said first and second surge suppression devices, or
(b) a third surge suppression device electrically connected between said line terminal and said neutral terminal and including a third voltage rating, a fourth surge suppression device electrically connected between said neutral terminal and said ground terminal and including a fourth voltage rating which is about equal to said third voltage rating, and a fifth surge suppression device electrically connected between said line terminal and said ground terminal, said fifth surge suppression device including a fifth voltage rating which is about 30 V_{RMS} to about 50 V_{RMS} greater than the third and fourth voltage ratings,
wherein a limited energy, line-to-neutral fault between said line terminal and said neutral terminal or a limited energy, line-to-ground fault between said line terminal and said ground terminal above a first predetermined magnitude will produce a ground fault current in said ground conductor sufficient to trip said circuit interrupter, and
wherein a limited energy, line-to-neutral fault between said line terminal and said neutral terminal or a limited energy, line-to-ground fault between said line terminal and said ground terminal below said first predetermined magnitude and above a second predetermined magnitude, which is less than said first predetermined magnitude, will produce a ground current in said ground conductor insufficient to trip said circuit interrupter.

2. The power system of claim 1 wherein said surge suppression circuit comprises said third, fourth and fifth suppression devices.

3. The power system of claim 2 wherein said third and fourth voltage ratings are about 130 V_{RMS}.

4. The power system of claim 1 wherein said surge suppression circuit comprises said first and second surge suppression devices and generally has no over-voltage protection device between said line terminal and said ground terminal other than the series combination of said first and second surge suppression devices.

5. The power system of claim 4 wherein the first voltage rating of said first surge suppression device is about 130 V_{RMS}.

6. A surge receptacle apparatus comprising:
a line terminal;
a neutral terminal;
a ground terminal;
a number of outputs electrically interconnected with said line terminal, said neutral terminal and said ground terminal;
a first surge suppression device electrically connected between said line terminal and said neutral terminal, said first surge suppression device including a first voltage rating;
a second surge suppression device electrically connected between said neutral terminal and said ground terminal, said second surge suppression device including a second voltage rating which is about equal to said first voltage rating; and
a third surge suppression device electrically connected between said line terminal and said ground terminal, said third surge suppression device including a third voltage rating which is about 30 V_{RMS} to about 50 V_{RMS} greater than said first and second voltage ratings.

7. The surge receptacle apparatus of claim 6 wherein said outputs are a plurality of alternating current female receptacles.

8. The surge receptacle apparatus of claim 6 wherein each of said first, second and third surge suppression devices includes a fuse in series with a metal oxide varistor.

9. The surge receptacle apparatus of claim 6 wherein said first, second and third surge suppression devices are MOVs.

10. The surge receptacle apparatus of claim 6 wherein said first and second voltage ratings are about 130 V_{RMS}.

11. A surge receptacle apparatus comprising:
a line terminal;
a neutral terminal;
a ground terminal;
a number of outputs electrically interconnected with said line terminal, said neutral terminal and said ground terminal;
a first surge suppression device electrically connected between said line terminal and said neutral terminal, said first surge suppression device including a first voltage rating; and
a second surge suppression device electrically connected between said neutral terminal and said ground terminal, said second surge suppression device including a second smaller voltage rating of about 30 V_{RMS} to about 50 V_{RMS},
wherein said surge receptacle apparatus generally has no over-voltage protection device between said line terminal and said ground terminal other than the series combination of said first and second surge suppression devices.

12. The surge receptacle apparatus of claim 11 wherein said first and second surge suppression devices are MOVs.

13. The surge receptacle apparatus of claim 11 wherein the first voltage rating of said first surge suppression device is about 130 V_{RMS}.

14. The surge receptacle apparatus of claim 11 wherein the first voltage rating of said first surge suppression device is about 80 V_{RMS} to about 100 V_{RMS} greater than the second voltage rating of said second surge suppression device.

15. The surge receptacle apparatus of claim 11 wherein said first surge suppression device includes a first fuse in series with a first metal oxide varistor; and wherein said second surge suppression device includes a second fuse in series with a second metal oxide varistor.

16. The surge receptacle apparatus of claim 15 wherein the first fuse is electrically connected to the first metal oxide varistor at a node; wherein said first surge suppression device further includes a resistor having first and second leads, a diode having an anode and a cathode, and a light having a first lead and a second lead; wherein the first lead of said resistor is electrically connected to said node; wherein the second lead of said resistor is electrically connected to the anode of said diode; wherein the cathode of said diode is electrically connected to the first lead of said light; and wherein the second lead of said light is electrically connected to said neutral terminal.

17. The surge receptacle apparatus of claim 15 wherein the second fuse is electrically connected to the second metal oxide varistor at a node; wherein said second surge suppression device further includes a resistor having first and second leads, first, second and third diodes each having an anode and a cathode, and a light having a first lead and a second lead; wherein the first lead of said resistor is electrically connected to said line terminal; wherein the second lead of said resistor is electrically connected to the anode of said first diode; wherein the cathode of said first diode is electrically connected to the anodes of said second and third diodes; wherein the cathode of said second diode is electrically connected to the first lead of said light; wherein the second lead of said light is electrically connected to said neutral terminal; and wherein the cathode of said third diode is electrically connected to said node.

18. The surge receptacle apparatus of claim 15 wherein said first surge suppression device further includes a first indicator circuit structured to indicate when said first fuse is open; and wherein said second surge suppression device further includes a second indicator circuit structured to indicate when said second fuse is open.

19. The surge receptacle apparatus of claim 11 wherein said line terminal, said neutral terminal and said ground terminal are disposed on a three-terminal plug.

20. The surge receptacle apparatus of claim 11 wherein said number of outputs are a plurality of outputs.
